(19) United States
(12) Patent Application Publication
(10) Pub. No.: US 2023/0177269 A1
(43) Pub. Date: Jun. 8, 2023

(54) CONVERSATION TOPIC EXTRACTION

(71) Applicant: salesforce.com, inc., San Francisco, CA (US)

(72) Inventors: Jessica Lundin, Bellevue, WA (US); Sönke Rohde, San Francisco, CA (US); Owen Winne Schoppe, Orinda, CA (US); Michael Sollami, Cambridge, MA (US); David Woodward, Bozeman, MT (US); Brian Lonsdorf, San Francisco, CA (US); Alan Martin Ross, San Francisco, CA (US); Scott Bokma, San Francisco, CA (US)

(21) Appl. No.: 17/545,168

(22) Filed: Dec. 8, 2021

(51) Int. Cl. G06F 40/289; G06N 20/00

(52) U.S. Cl. CPC G06F 40/289; G06N 20/00

(57) ABSTRACT

Systems, devices, and techniques are disclosed for conversation topic extraction. Text of a communication channel may be received. The text of the communication channel may be divided into conversation documents based on conversation threads of the communication channel. Phrases of the text of the conversation documents may be tokenizes. Topic phrases for the conversation documents may be determined by assigning importance scores to the tokenized phrases using unsupervised topic extraction. The topic phrases may be the tokenized phrases with the highest importance scores.

### BACKGROUND

Text-based communication channels may include various conversations. Different conversations within a communication channel may be used for discussing topics that may relate to an overall topic of the communication channel. Knowing what topics the different conversations in a communication channel are about may allow for the conversations to be used in various manners, and it may be difficult and time consuming to determine these topics.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for conversation topic extraction according to an implementation of the disclosed subject matter.

FIG. 2A shows an example arrangement suitable for conversation topic extraction according to an implementation of the disclosed subject matter.

FIG. 2B shows an example arrangement suitable for conversation topic extraction according to an implementation of the disclosed subject matter.

FIG. 2C shows an example arrangement suitable for conversation topic extraction according to an implementation of the disclosed subject matter.

FIG. 3 shows an example arrangement suitable for conversation topic extraction according to an implementation of the disclosed subject matter.

FIG. 4A shows an example arrangement suitable for conversation topic extraction according to an implementation of the disclosed subject matter.

FIG. 4B shows an example arrangement suitable for conversation topic extraction according to an implementation of the disclosed subject matter.

FIG. 4C shows an example arrangement suitable for conversation topic extraction according to an implementation of the disclosed subject matter.

FIG. 5A shows an example arrangement suitable for conversation topic extraction according to an implementation of the disclosed subject matter.

FIG. 5B shows an example arrangement suitable for conversation topic extraction according to an implementation of the disclosed subject matter.

FIG. 6A shows an example arrangement suitable for conversation topic extraction according to an implementation of the disclosed subject matter.

FIG. 6B shows an example arrangement suitable for conversation topic extraction according to an implementation of the disclosed subject matter.

FIG. 6C shows an example arrangement suitable for conversation topic extraction according to an implementation of the disclosed subject matter.

FIG. 6D shows an example arrangement suitable for conversation topic extraction according to an implementation of the disclosed subject matter.

FIG. 6E shows an example arrangement suitable for conversation topic extraction according to an implementation of the disclosed subject matter.

FIG. 7 shows an example procedure suitable for conversation topic extraction according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable conversation topic extraction, which may allow for topic phrases to be determined for conversations that are part of a communication channel. The text of a communication channel may be received. The text of the communication channel may be divided into conversation documents based on conversation threads of the communication channel. Phrases of the text of the conversation documents may be tokenized. Importance scores may be assigned to the tokenized phrases using unsupervised topic extraction to determine topic phrases for the conversation documents. The topic phrases for the conversation documents may be the tokenized phrase with the highest importance scores. Assigning importance scores to the tokenized phrases may include using supervised topic extraction to update the importance scores assigned to the tokenized phrases. A conversation thread may be sent to a recipient selected based on the topic phrases for the conversation document associated with the conversation thread. A summary for the communication channel may be generated and may include topic phrases for the conversation documents into which the text of the communication channel was divided.

The text of a communication channel may be received. The communication channel may be, for example, a channel for text-based communications that is part of a communications platform. The communication channel may include text for messages added to the channel by users of the communications platform. A communication channel may be designated for communicating about a general subject. For example, a communication channel that is a part of a communications platform for a business may be designated for discussing technical support issues within the business, while another communication channel on the same communications platform for the business may be designated for discussing a particular brand or product line. A communication channel may be threaded, and may include multiple separate conversations which may have their own threads within the communication channel. For example, a communication channel designated for discussing technical support issues may have separate conversation threads, with users starting new conversation threads when they post messages about new technical support issues. The text of a communication channel may be received at any suitable computing device. The received text may include, for example, the text of messages from the communication channel, and may preserve both differentiation between messages and any threading of the messages. The threading may be preserved by, for example, conversation identifiers assigned to messages from the same conversation by the communications platform. The conversation identifier for a message may be included along with the text of the message in the received text of the communication channel. Data identifying the users who added the textual messages to the communication channel may not be part of the received text, or users may be deidentified or otherwise have their identities obscured. Non-text data in a communication channel, such as file attachments and inline images, may not be received.

The text of the communication channel may be divided into conversation documents. A conversation document may include the text from a single conversation thread of the communication channel. The text may be divided into conversation documents based on threading information in the received text of the communication channel. For example, if messages are assigned conversation identifiers, text for a single conversation thread may be identified from the text of the communication channel as text that has the same conversation identifier. Text with the same conversation identifier may be added to a conversation document for the conversation thread. The text of a communication channel may be divided into any suitable number of conversation documents. For example, the text may be divided into one conversation document for each conversation thread in the text of the communication channel, as determined, for example, by the number of unique conversation identifiers in the received text of the communication channel. In some implementations, the text from a communications platform may be divided at other levels of granularity. For example, the messages in a conversation thread from a communication channel may be divided into their own conversation documents, with each conversation document including text from a single message from the conversation thread. As another example, a communications platform may have multiple communication channels, and the text of each communication channel, including all conversation threads in a communication channel, may be used as the basis for a conversation document. This may result in each conversation document including the text from all of the messages in all of the conversation threads of one of the communication channels of the communications platform.

For example, a communication channel designated for communicating about technical support issues may include a first conversation thread started by a user who has lost access to a VPN, a second conversation thread started by a user who needs a laptop replaced, and a third conversation thread started by a user who needs their password reset. The messages for the first conversation thread may have been assigned a first conversation identifier, the messages for the second conversation thread may have been assigned a second conversation identifier, and the messages for the third conversation thread may have been assigned a third conversation identifier. When a computing device receives the text of the communication channel, the text from messages of the first conversation thread may include the first conversation identifier, the text from messages of the second conversation thread may include the second conversation identifier, and the text from messages of the third conversation thread may include the third conversation identifier To divide the text of the communication channel into conversation documents, text that has the same conversation identifier may be added to a conversation document that includes only text with that conversation identifier. For example, text that has the first conversation identifier may be added to a first conversation document, text that has the second conversation identifier may be added to a second conversation document, and text that has the third conversation identifier may be added to a third conversation document. This may result in the first conversation document including text from textual messages of the conversation thread started by the user who has lost access to a VPN, the second conversation document including text from the textual messages of the conversation thread started by the user who needs a laptop replaced, and the third conversation document including text from textual messages of the conversation thread started by the user who needs their password reset.

Phrases of the text of the conversation documents may be tokenized. The conversation documents may be tokenized using any suitable tokenizer. The tokenizer may generate any number of n-gram tokenizations of phrases from the text of the conversation documents. For example, the tokenizer may generate token vectors that may include counts for one-word, two-word, and three-word phrases from the text of the conversation documents. The tokenization of the conversation documents may generate for each conversation document a vector representation of the phrases, which may be the tokens, in that conversation document. The vector representation may be, for example, a vector with indexes mapped to the phrases extracted from a conversation document and the cell at each index storing a count of the number of times the phrase the index is mapped to occurs in the conversation document. For example, tokenized phrases from text of a conversation document for a conversation thread started by a user who has lost access to a VPN may result in tokenized phrases such as “VPN”, “login” “passcode generator”, phone”, “help”, and “reset”, which may be represented in a vector for the conversation document that may store counts of how many times each of the phrases occurs in the conversation document. The tokenizer may tokenize a number of conversation documents together, so that the same indexes of the token vectors generated for each of the conversation documents are mapped to the same phrases. The tokenizer may also limit the size of the token vectors, for example, by counting the occurrence of phrases across the text of all of the conversation documents being tokenized together and generating the token vectors to represent the phrases that occur the most, for example, the 500 most recurrent phrases across the conversation documents. The text of the conversation documents may also be cleaned and prepared for tokenization in any suitable manner before being tokenized. The vectors generated by the tokenizer may be token vectors for the conversation documents they are generated from.

In some implementations, tokenization may use known phrases for a communication channel in determining how to tokenize phrases from the text of the conversation documents. The known phrases for a communication channel may be associated with the communication channel, for example, based on the general subject designated to the communication channel. For example, the known phrases for a communication channel with a designated subject of technical support issues may be taken from a corpus of technical support phrases. The tokenizer may prioritize the known phrases, ensuring that any known phrases that appear in the text of the conversation documents gets tokenized. For example, a communication channel may be designated to discuss a specific brand of shoes. Existing data about the brand of shoes, such as, for example slogans used by the brand, names of the brand's shoes, and names of features of the brand's shoes, may be used by the tokenizer when tokenizing text for conversation documents associated with the conversation channels of the communication channel. In this way, if the slogan used by the brand of shoes appears in the text of a conversation document, the tokenizer may prioritize tokenizing the slogan, even if the slogan is an n-gram longer than what a tokenizer may ordinarily tokenize. For example, the tokenizer may normally tokenize one-word, two-word, and three-word phrases, and the slogan may be five words long. Using the existing data about the brand of shoes may cause the tokenizer to tokenize the slogan anyway. An unsupervised model may be used to group words in conversation documents for a communication channel based on known phrases for the communication channel before the conversation documents are tokenized. This may assist the tokenizer in locating known phrases within the conversation documents. The known phrases for a communication channel may be come from any suitable source. For example, noun-phrase extraction may be performed across communication channels with similar designated subjects to generate known phrases that may be used in tokenizing conversation documents for conversation threads from any of the communication channels. A brand, for example, may have multiple different communication channels on a communications platform, which may all have designated subjects that are related to the brand. Known phrases for a communication channel may also be extracted from sources external to the communication channel. For example, a brand may have various online assets, such as websites, from which phrases may be extracted to be used as known phrases when tokenizing phrases from text of conversation documents for conversation threads from a communication channel for the brand.

Importance scores may be assigned to the tokenized phrases using unsupervised topic extraction to determine topic phrases for the conversation documents. The unsupervised topic extraction may be performed, for example, using a dimensionality-reduction technique, such as non-negative matrix factorization (NMF) or latent Dirichlet allocation (LDA), or using a neural network model. For example, the token vectors generated by the tokenizer for each conversation document may be used to generate a matrix that may include all tokens across all of the conversation documents that were tokenized, representing all of the conversation threads whose text was received from the communication channel. The matrix generated from the token vectors may then have dimensionality-reduction, such as NMF or LDA, performed on it. Performing dimensionality-reduction on the matrix generated from the token vectors may generate two matrices. The first matrix may be a topic distribution of the tokenized phrases which may include assigned weights to the tokenized phrases indicating how representative that tokenized phrase is of a topic in the topic distribution. The topics of the topic distribution created by performing dimensionality reduction may be unlabeled categories. The second matrix may include assigned weights that indicate which of the topics represented in the first matrix are most representative of the token vectors of the input matrix, and by association, of the conversation documents and conversation threads. An importance score may be assigned by the dimensionality-reduction to the tokenized phrases from the token vectors for each conversation document based on the first and second matrixes, for example, based on how representative a tokenized phrase is of a topic, and how representative a topic is of a token vector. For example, a tokenized phrase that is very representative of topic that is very representative of a token vector may be assigned a high importance score. The importance scores may be assigned on a per-token vector, and therefore per-conversation document, basis. The same tokenized phrase that appears in more than one of the conversation documents, and more than one of the token vectors, may assigned a different importance score between the two token vectors, and two conversation documents. For example, the phrase “password” may appear in both conversation documents with text from a conversation thread started by a user who has lost access to a VPN and a conversation thread started by a user who needs their password reset. “password” may be tokenized in generating the token vectors for both conversation documents, but may be assigned a different importance score for each conversation document, as the dimensionality-reduction may determine that “password” is more important, and more likely to be a topic phrase, for one of the conversation documents than for the other. For example, “password” may have a higher importance score for the conversation document with text from the conversation thread started by the user who needs their password reset.

Assigning importance scores to the tokenized phrases may also include using supervised topic extraction to update the importance scores assigned to the tokenized phrases. For example, the importance scores assigned using unsupervised topic extraction may be considered weak labels for the tokenized phrases. The token vectors and a subset of tokenized phrases and their importance scores may be used as a weakly labeled training data set to train a supervised topic extraction model, such as, for example, a supervised neural network model or supervised statistical model. The trained supervised topic extraction model may then be used to update importance scores for the all of the tokenized phrases in the token vectors.

The topic phrase for a conversation document may be the tokenized phrase with the highest importance score. Each conversation document may have its own set of importance scores for the tokenized phrases from the conversation document. The tokenized phrase assigned the highest importance score, either through unsupervised topic extraction alone or unsupervised topic extraction followed by supervised topic extraction, for a conversation document may be used as the topic phrase for the conversation document and its associated conversation thread. In some implementations, a conversation document may have multiple topic phrases. For example, the three tokenized phrases with the highest importance scores for a conversation document may be used as topic phrases for that conversation document and its associated conversation thread.

A conversation thread may be sent to a recipient selected based on the topic phrases for the conversation document associated with the conversation thread. The topic phrases for the conversation document associated with the conversation thread may be used to determine an appropriate recipient for the conversation thread to be sent to based on any suitable routing rules or heuristics. For example, if the topic phrase for a conversation document from a communication channel for technical support issues is “VPN”, this may be used to determine that the associated conversation thread should be sent to technical support personnel who specialized in VPN issues. A conversation thread may be sent to a recipient in any suitable manner, including, for example, as a link to the conversation thread on the communication platform.

A summary for the communication channel may be generated and may include topic phrases for the conversation documents into which the text of the communication channel was divided. The summary may be in any suitable format, and may be, for example, a message added to the communication channel. The summary may include the topic phrases for the conversation documents associated with the conversation threads of the communication channel. The topic phrases may be presented in order of importance score and alongside the text of messages from the conversations threads.

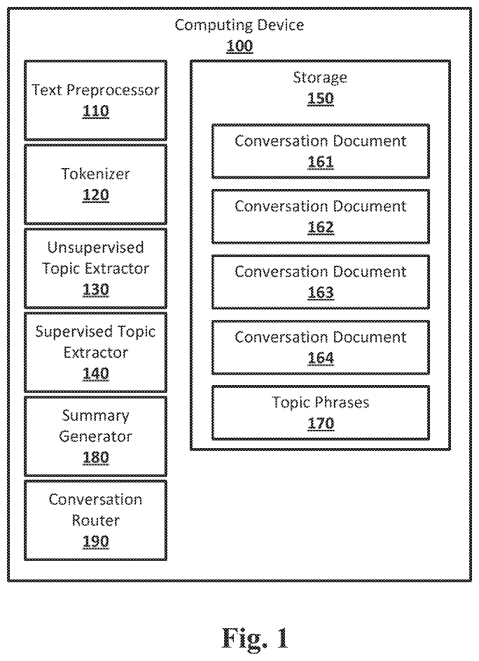

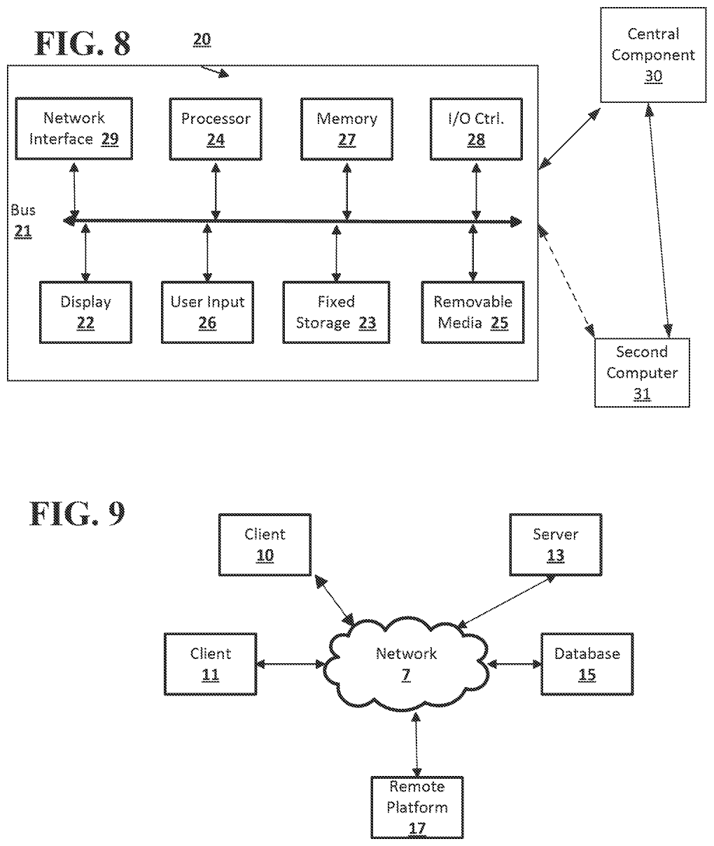

FIG. 1 shows an example system suitable for conversation topic extraction according to an implementation of the disclosed subject matter. A computing device 100 may be any suitable computing device, such as, for example, a computer 20 as described in FIG. 8, or component thereof, for implementing conversation topic extraction. The computing device 100 may include a text preprocessor 110, a tokenizer 120, an unsupervised topic extractor 130, a supervised topic extractor 140, a summary generator 180, and a conversation router 190, and a storage 150. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs).

The text preprocessor 110 may be any suitable combination of hardware and software of the computing device 100 for generating conversation documents from the text of a communication channel. The text preprocessor 110 may receive the text of a communication channel in any suitable manner, including, for example, through crawling the communication channel, accessing the communication channel through an API, or through receiving the text of the communication channel in an already prepared file. The text may be text of messages posted in the communication channel by users. The text preprocessor 110 may divide the text of the communication channel into conversation documents based on the conversation threads of the communication channel. A conversation document may include the text of a single conversation thread from a communication channel. In generating conversation documents, the text preprocessor 110 may remove any non-text elements that have not already been removed from the received text of the communication channel, and may also remove any user identifiers, whether or not users have already been deidentified or had their user identifiers obscured. The text preprocessor 110 may determine the text that belongs to a conversation thread based on conversation identifiers attached to or otherwise associated with the text, so that each conversation document includes text from a single conversation thread of the communication channel. The conversation identifiers may have been added to the messages posted in the communication channel by the communications platform in order to track which messages belong to which conversation thread. Conversation documents generated by the text preprocessor 110 may be stored in the storage 150, for example, as conversation documents 161, 162, 163, and 164. Each of the conversation documents 161, 162, 163, and 164 may include text from a separate conversation thread of the communication channel whose text was received by the text preprocessor 110.

The tokenizer 120 may be any suitable combination of hardware and software of the computing device 100 for generating token vectors from conversation documents. The tokenizer 120 may generate any number of n-gram tokenizations of the text of the conversation documents generated by the text preprocessor 110, such as the conversation documents 161, 162, 163, and 164. For example, the tokenizer 120 may generate a tokenization that may include one-word, two-word, and three-word phrases from the text of the conversation documents, with counts of how many times each of the phrases occurs in each conversation document. The tokenization of the conversation documents may generate for each conversation document a vector representation of the phrases, which may be the tokens, in that conversation document, including counts of how many times each of the phrases occurs in that conversation document, along with a mapping of the indexes of generated token vectors to tokenized phrases. For example, if the conversation document 161 includes the phrase “VPN” seven times, the token vector generated by the tokenizer 120 from the conversation document 161 may include a cell whose index is mapped to the phrase “VPN” and that stores the number seven. The vectors generated by the tokenizer 100 may be the token vectors for the conversation documents they are generated from. The tokenizer 120 may generate tokenize the conversation documents 161, 162, 163, and 164 together, and may generate a separate token vector for each of the conversation documents 161, 162, 163, and 164. The same indexes across the token vectors for the conversation documents 161, 162, 163, and 164 may be mapped to the same phrases. The token vectors generated by the tokenizer 120 may be of any suitable size. For example, the tokenizer 120 may limit the size of the token vectors for the conversation documents 161, 162, 163, and 164 to the 500 phrases that occur most often across the conversation documents 161, 162, 163, and 164. This may result in, for example, the token vectors for the conversation documents 161, 162, 163, and 164 having indexes from 0 to 499, with the same indexes across token vectors mapped to the same phrases from the conversation documents 161, 162, 163, 164, and cells at those indexes storing the counts of occurrences of those phrases in each separate conversation document 161, 162, 163, and 164. The counts stored by a token vector may be specific to the conversation document used to generate the token vector. The token vectors generated by the tokenizer 120 may be stored in the storage 150, or may be sent directly to the unsupervised topic extractor 130.

In some implementations, the tokenizer 120 may use known phrases for a communication channel in determining how to tokenize phrases from the text of the conversation documents. The known phrases for a communication channel may be associated with the communication channel, for example, based on the general subject designated to the communication channel. The tokenizer 120 may prioritize the known phrases when generating the token vectors for the conversation documents 161, 162, 164, and 164. The known phrases may be received by the tokenizer 120 from any suitable source and may have been generated in any suitable manner. For example, the known phrases for a communication channel may have been generated using noun-phrase extraction across communication channels with similar designated subjects to the communication channel, or may have been generated through extraction from external sources, such as websites, associated with the designated subject of the communication channel.

The unsupervised topic extractor 130 may be any suitable combination of hardware and software of the computing device 100 for generating and assigning importance scores to tokenized phrases in token vectors using unsupervised topic extraction techniques. The unsupervised topic extractor 130 may, for example, use any suitable dimensionality-reduction technique, such as non-negative matrix factorization (NMF) or latent Dirichlet allocation (LDA), or a neural network model. The unsupervised topic extractor 130 may use as input the token vectors generated by tokenizer 120. For example, the token vectors may be used to generate a matrix that may include all tokens across all of the conversation documents 161, 162, 163, and 164, representing all of the conversation threads whose text was received from the communication channel by the text preprocessor 110. The tokenizer 120 may then perform dimensionality-reduction on the matrix generated from the token vectors, assigning importance scores to the tokenized phrases of the token vectors. The importance scores may be assigned on a per-token vector, and therefore per-conversation document, basis. For example, the same phrase may be represented in the token vectors for the conversation document 161 and the conversation document 162. The unsupervised topic extractor 110 may assign the phrase an importance score in the token vector for the conversation document 161 that is different from the importance score the unsupervised topic extractor 110 assigns to the same phrase in the token vector for the conversation document 162.

The importance scores assigned to the tokenized phrases of the token vectors by the unsupervised topic extractor 130 may be used to determine which tokenized phrases are topic phrases for the conversation documents 161, 162, 163, and 164. For example, the tokenized phrase with the highest importance score in the token vector for the conversation document 161 may be used as the topic phrase for the conversation document 161, and the conversation thread associated with the conversation document 161, and may be stored, for example with topic phrases. Each conversation document 161, 162, 163, and 164 may have its own topic phrase, and may have more than one topic phrase, for example, having n topic phrases based on the tokenized phrases with the n highest importance scores in their respective token vectors.

The supervised topic extractor 140 may be any suitable combination of hardware and software of the computing device 100 for updating assigned importance scores using any suitable supervised topic extraction techniques. The importance scores assigned to tokenized phrases by the unsupervised topic extractor 130 may be considered weak labels for the tokenized phrases. The token vectors and a subset of tokenized phrases and their importance scores may be used as a weakly labeled training data set to train the supervised topic extractor 140, which may implement any suitable supervised topic extraction model, such as, for example, a supervised neural network model or supervised statistical model. After being trained using the importance scores generated and assigned by the unsupervised topic extractor 143, the supervised topic extractor 140 may then be used to update importance scores for the all of the tokenized phrases in the token vectors. The updated importance scores may be used to determine the topic phrases for the conversation documents 161, 162, 163, and 164, which may be stored with the topic phrases 170.

The summary generator 180 may be any suitable combination of hardware and software of the computing device 100 for generating a summary of a communication channel. The summary generator 180 may, for example, use topic phrases from the topic phrases 170 to generate a summary of the communication channel whose text was used to generate the conversation documents 161, 162, 163, and 164. The summary generator 180 may add the summary as a message in the communication channel.

The conversation router 190 may be any suitable combination of hardware and software of the computing device 100 for sending a conversation thread to recipient selected based on topic phrases for the conversation thread. The conversation router 190 may, for example, use a topic phrase from the topic phrases 170 for one of the conversation documents, for example, the conversation document 161, to determine a recipient to send the conversation thread associated with the conversation document. For example, the topic phrase for the conversation document 161, as stored in the in the topic phrases 170, may be “VPN.” The conversation router 190 may select a recipient based on this topic phrase, for example, an appropriate technical support personnel, and send the conversation thread associated with the conversation document 161 to the selected recipient. The conversation router 190 may send a conversation thread to a recipient in any suitable manner, including sending a link to the conversation thread on the communication platform, or sending the text of the conversation thread itself, to the recipient.

The storage 150 may be any suitable combination of hardware and software for storing data. The storage 150 may include any suitable combination of volatile and non-volatile storage hardware, and may include components of the computing device 100 and hardware accessible to the computing device 100, for example, through wired and wireless direct or network connections. The storage 150 may store the conversation documents 161, 162, 163, and 164 and the topic phrases 170. The storage 150 may also store, as necessary, token vectors, matrices generated from the token vectors, and any output from the unsupervised topic extractor 130 and supervised topic extractor 140, including the importance scores assigned to the tokenized phrases in the token vectors. The storage 150 may also store known phrases that may be used by the tokenizer 120 when tokenized the conversation documents 161, 162, 163, and 164.

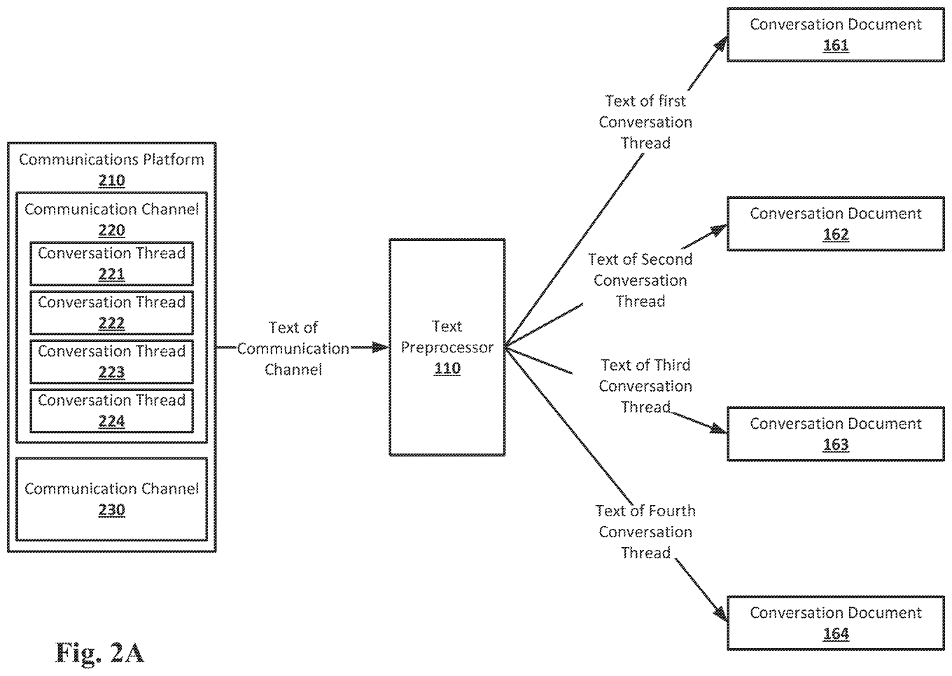

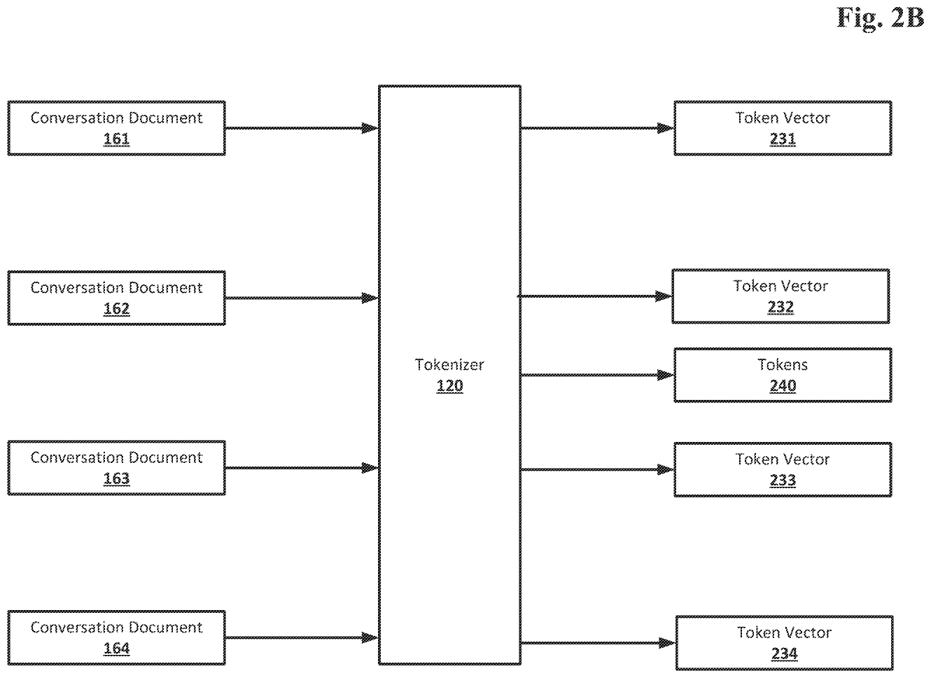

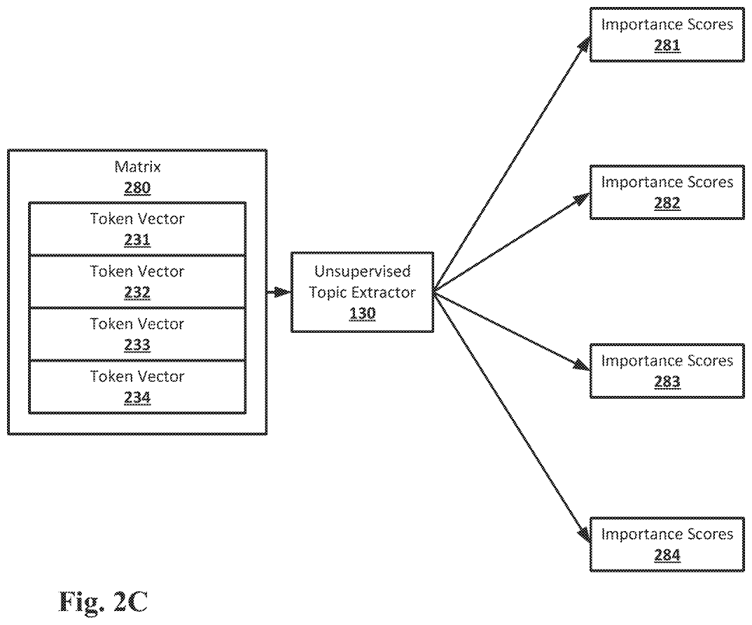

FIG. 2A shows an example arrangement suitable for conversation topic extraction according to an implementation of the disclosed subject matter. The text preprocessor 210 may receive the text of a communication channel 220 that may be part of a communications platform 210. The communications platform 210 may be a platform for hosting text based communication channels, such as the communication channels 220 and 230, and may also allow for other forms of communications, including video and audio communication. The communication channels 220 and 230 may have different designated subjects, which may be used by users of the communications platform 210 to determine where to post messages about different subjects. The communications platform 210 may store data for communication channels, such as the communication channel 220, on any suitable computing device or system, including the computing device 100 or a computing device that is part of a separate server system.

The text preprocessor 110 may receive the text of the communication channel 220 in any suitable manner. For example, the text preprocessor 110 may crawl the communication platform 220, access the communication channel 220 through an API of the communications platform 210, or directly access the stored data for the communication channel 220. The text of the communication channel 220 may include the text of messages posted in all of the conversation threads of the communication channel 220, for example, the conversation threads 221, 222, 223, and 224, each of which may be a conversation started by a user of the communications platform 210 regarding a subject related to the designated subject of the communication channel 220. For example, the communication channel 220 may be designated for discussing technical support issues, and the conversation threads 221, 222, 223, and 224 may have been started by users with their own technical supports issues and include messages discussing those issues. The text of the messages from the conversations threads 221, 222, 223, and 224 received as the text of the communication channel 220 by the text preprocessor 110 may include conversation identifiers that may be used to preserve the threading and differentiate between the text of messages posted in each of the conversation threads 221, 222, 223, and 224. The text of the communication channel 220 may also be deidentified or otherwise have user identifiers removed or obscured, and non-text data, such as file attachments and inline images, may also be removed, either before or after the text of the communication channel 220 is received by the text preprocessor 110.

The text preprocessor 110 may divide the text of the communication channel 220 into the conversation documents 161, 162, 163, and 164. Each of the conversation documents 161, 162, 163, and 164 may include the text of one of the conversation threads 221, 222, 223, and 224. For example, the text preprocessor 110 may generate the conversation document 163 using the text of the conversation thread 221, generate the conversation document 163 using the text of the conversation thread 221, generate the conversation document 163 using the text of the conversation thread 223, and generate the conversation document 164 using the text of the conversation thread 224. The conversation documents 161, 162, 163, and 164 may include the text of the conversation thread whose text was used to generate them, stripped of conversation identifiers, user identifiers, and any non-text data.

FIG. 2B shows an example arrangement suitable for conversation topic extraction according to an implementation of the disclosed subject matter. The tokenizer 120 may receive the conversation documents 161, 162, 163, and 164, and generate token vectors 231, 232, 233, and 234 and tokens 240. The conversation documents 161, 162, 163, and 164 may be tokenized together, so that the same indexes across the token vectors 231, 232, 233, 234 are mapped to the same phrases from the conversation documents 161, 162, 163, and 164. The mapping may be stored in the tokens 240, which may include tokenized phrases and their mapped indexes in the token vectors 231, 232, and 233. The tokenizer 120 may limit the size of the token vectors 231, 232, 233, and 234, for example, to the top n most recurrent n-gram phrases across the conversation documents 161, 162, 163, and 164. Each of the token vectors 231, 232, 233, and 234 may be generated from one of the conversation documents 161, 162, 163, and 164 and may store counts of the occurrence of phrases in that conversation document. For example, the token vector 231 may be generated from the conversation document 161, the token vector 232 may be generated from the conversation document 162, the token vector 233 may be generated from the conversation document 163, and the token vector 234 may be generated from the conversation document 164. The phrases counted in each of the conversation documents 161, 162, 163, and 164, may be the n-gram phrases that the indexes of the token vectors 231, 232, 233, and 234 are mapped to, for example, based on counting the total occurrences of these n-gram phrases across the conversation documents 161, 162, 163, and 164. To generate the token vector 231, the tokenizer 120 may count the occurrences of n-gram phrases mapped to by the indexes of the token vector 231 in the conversation document 161, which may include the text of the conversations thread 221. If the indexes of the token vector 231 map to one-word, two-word, and three-word phrases, the tokenizer 120 may count, for example, one-word, two-word, and three-word phrases from the conversation document 161 to generate the token vector 231. The tokenizer 120 may also use known phrases for the communication channel 220, received from any suitable source, when generating the token vectors 231, 232, 233, and 234, for example, using checking the conversation documents 161, 162, 163, and 164 for the known phrases when counting the occurrences of phrases across all of the conversation documents 161, 162, 163, and 164 when determining which phrases will be represented as tokenized phrases by the token vectors 231, 232, 233, and 234.

FIG. 2C shows an example arrangement suitable for conversation topic extraction according to an implementation of the disclosed subject matter. The unsupervised topic extractor 130 may receive a matrix 280, including the token vectors 231, 232, 233, and 234, and generate importance scores 281, 282, 283, and 284. The unsupervised topic extractor 130 may, for example, perform dimensionality-reduction on the matrix 280, which may generate a matrix that includes importance scores for the tokenized phrases from the token vectors 231, 232, 233, and 234. The importance scores 281, 282, 283, and 284 may be taken from the matrix generated by the unsupervised topic extractor 130 from the matrix 280. The importance scores 281 may, for example, be importance scores for the tokenized phrases in the token vector 231, the importance scores 282 may, for example, be importance scores for the tokenized phrases in the token vector 232, The importance scores 283 may, for example, be importance scores for the tokenized phrases in the token vector 233, and the importance scores 284 may, for example, be importance scores for the tokenized phrases in the token vector 234. An importance score in the importance scores 281 for a tokenized phrase from the token vector 231 may represent how likely that that tokenized phrase is to be a topic phrase for the conversation document 161 and the conversation thread 221.

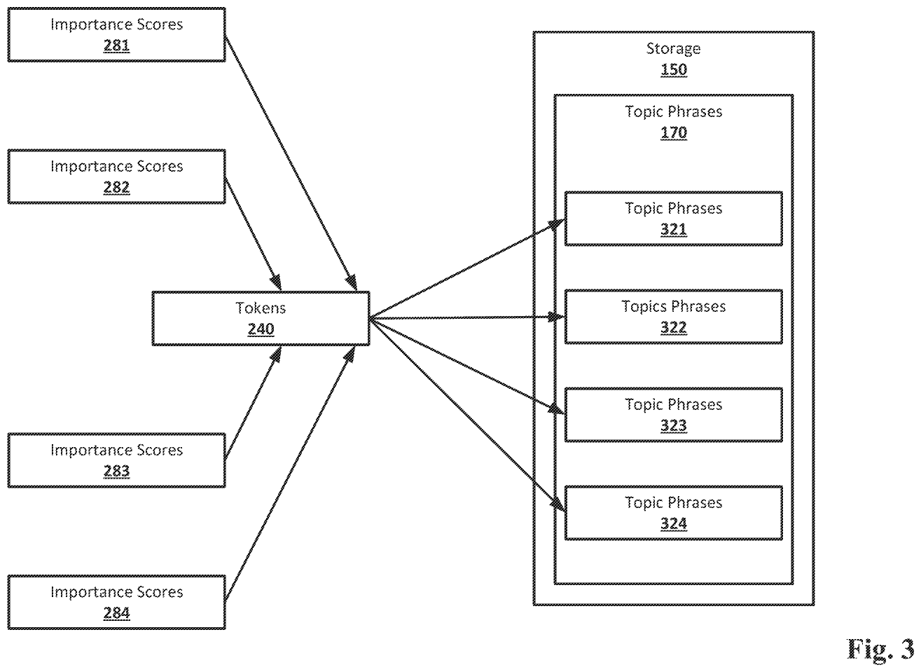

FIG. 3 shows an example arrangement suitable for conversation topic extraction according to an implementation of the disclosed subject matter. The importance scores generated by the unsupervised topic extractor 130 may be used to determine the topic phrases for the conversation documents 221, 222, 223, and 224. The tokenized phrases from the token vectors 231, 232, 233, and 234 with the highest importance scores in the importance scores 281, 282, 283, and 284 may be stored as topic phrases 321, 322, 323, 324. The tokenized phrases may be looked up by index in the tokens 240. Any number of tokenized phrase may be stored as topic phrases. For example, only the tokenized phrases with the highest importance scores in a token vector may be stored, or the tokenized phrases with the n highest importance scores, where n is any integer less than the total number of tokenized phrases, may be stored. For example, the tokenized phrases in the token vector 231 with the four highest importance scores in the importance scores 281 may be stored as the topic phrases 321 and may be the topic phrases for the conversation document 161, associated with the conversation thread 221. Similarly, the topic phrases 322 may be the tokenized phrases from the token vector 232 with the highest importance scores in the importance scores 282 and may be the topic phrases for the conversation document 162 and associated conversation thread 222, the topic phrases 323 may be the tokenized phrases from the token vector 233 with the highest importance scores in the importance scores 283 and may be the topic phrases for the conversation document 163 and associated conversation thread 223, and the topic phrases 324 may be the tokenized phrases from the token vector 234 with the highest importance scores in the importance scores 284 and may be the topic phrases for the conversation document 164 and associated conversation thread 224.

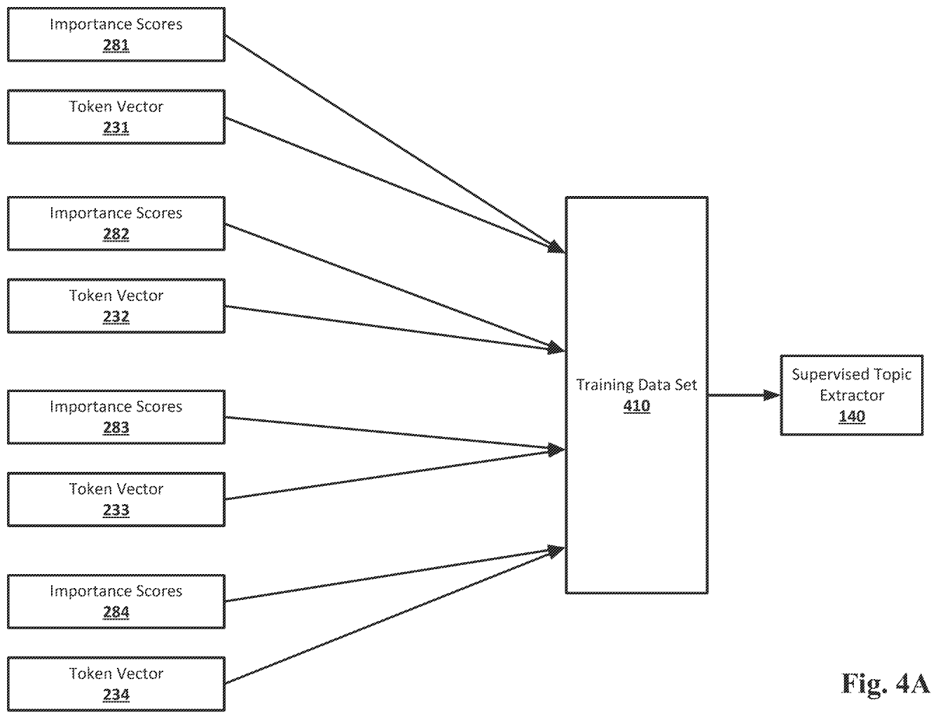

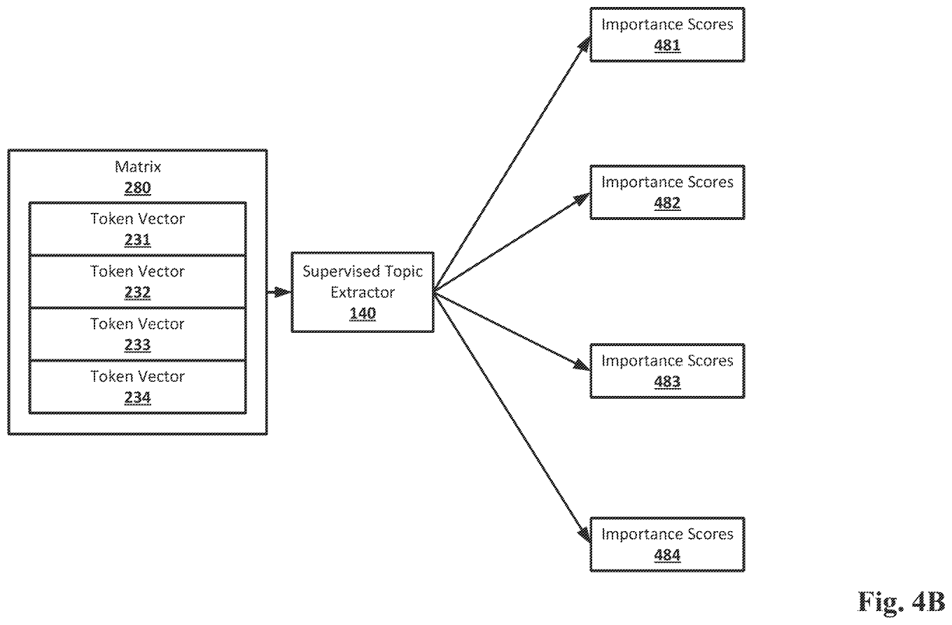

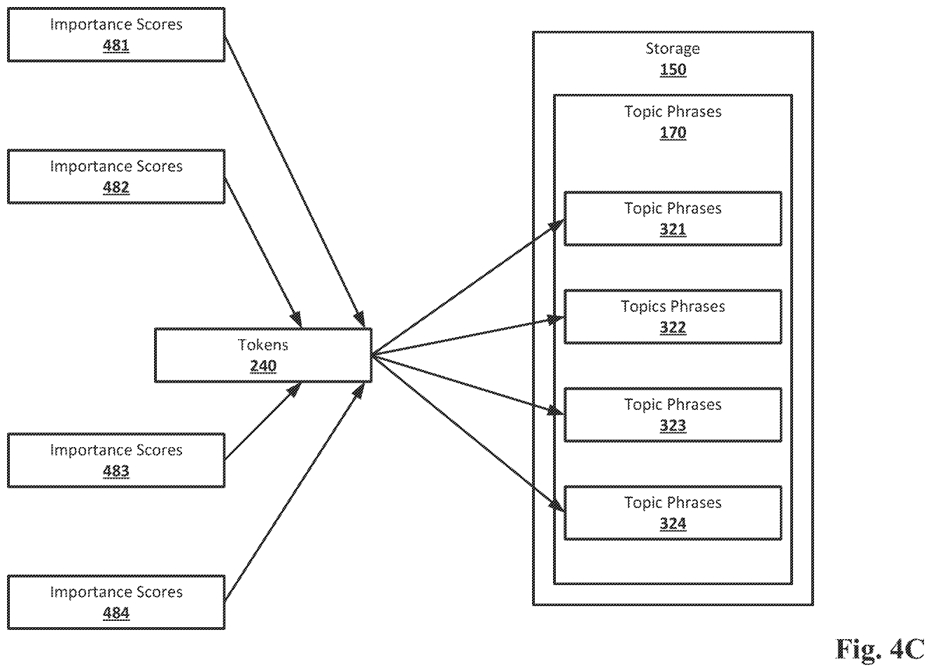

FIG. 4A shows an example arrangement suitable for conversation topic extraction according to an implementation of the disclosed subject matter. In some implementations, the importance scores 281, 282, 283, and 285 may be used along with the token vectors 231, 232, 233, and 234 to generate a training data set 410 of weakly labeled training data. The training data set 410 may be used to train the supervised topic extraction 140 using any suitable form of supervised training. For example, a subset of the importance scores in the importance scores 281, 282, 283, and 284 may be used as labels for cells of the token vectors 231, 232, 233, and 234 representing the tokenized vectors to which the scores were assigned. This may allow for the supervised topic extractor 140 to trained by comparing importance scores assigned to those labeled cells of the supervised topic extractor 140 when given the token vectors 231, 232, 233, and 234 as input to the importance scores output by the unsupervised topic extractor 130 and used as weak labels. In some implementations, the conversation documents 161, 162, 163, and 164 may be used as input to the supervised topic extractor 140 when training the supervised topic extractor 140.

FIG. 4B shows an example arrangement suitable for conversation topic extraction according to an implementation of the disclosed subject matter. After being trained using the training data set 410, the supervised topic extraction 140 may be used to update the importance scores assigned to the tokenized phrases represented by the token vectors 231, 232, 233, and 234. The token vectors 231, 232, 233, and 234 may be input to the supervised topic extractor 140, which may output importance scores 481, 482, 483, and 484. In some implementations, the conversation documents 161, 162, 163, and 164 may be used as input to the supervised topic extractor 140 when using the topic extractor 140 to update the importance scores for tokenized phrases.

FIG. 4C shows an example arrangement suitable for conversation topic extraction according to an implementation of the disclosed subject matter. The importance scores generated by the supervised topic extractor 140 may be used to determine the topic phrases for the conversation documents 221, 222, 223, and 224. The tokenized phrases from the token vectors 231, 232, 233, and 234 with the highest importance scores in the importance scores 481, 482, 483, and 484 may be stored as topic phrases 321, 322, 323, 324. The tokenized phrases may be looked up by index in the tokens 240.

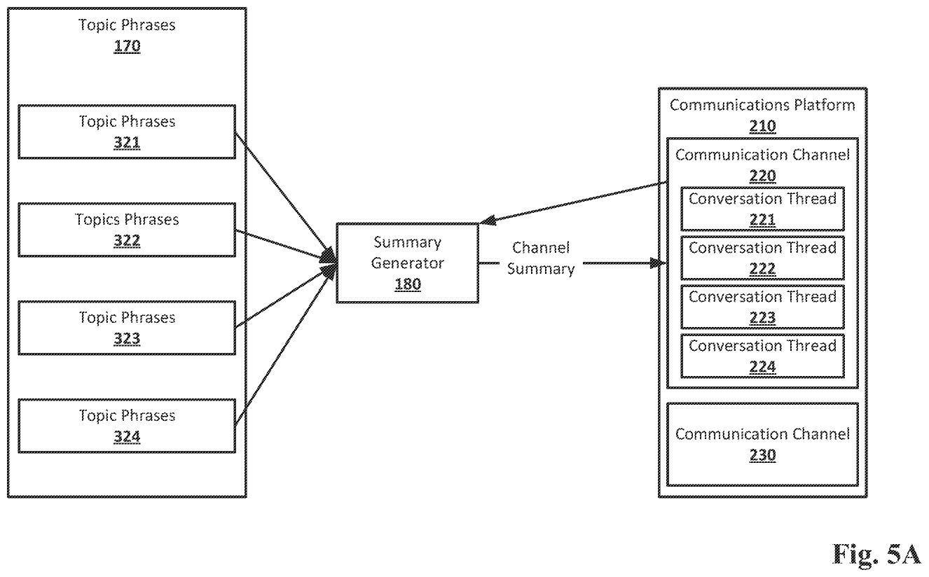

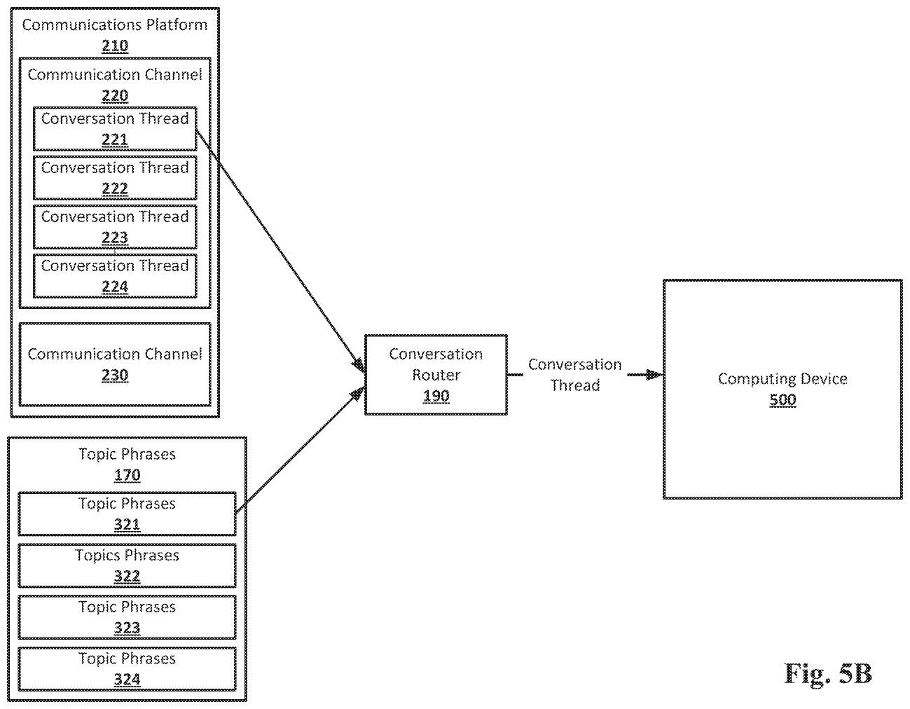

FIG. 5A shows an example arrangement suitable for conversation topic extraction according to an implementation of the disclosed subject matter. The summary generator 180 may use the topic phrases 321, 322, 323, and 324 to generate a channel summary for the communication channel 220. The topic phrases 321, 322, 323, and 324 may store, respectively, topic phrases for the conversations threads 221, 222, 223, and 224 of the communication channel 220. For example, the summary generator 180 may use phrases from the topics phrases 321, 322, 323, and 324 as headers for a channel summary, which may include other aspects of the communication channel 220, such as, for example, messages from any of the conversations threads 221, 222, 223, and 224, including messages that may include the phrases from the topic phrases 321, 322, 323, and 324.

FIG. 5B shows an example arrangement suitable for conversation topic extraction according to an implementation of the disclosed subject matter. The conversation router 190 may use the topic phrases 321, 322, 323, and 324 to send any of the conversation threads 221, 222, 223, and 224 to an appropriate recipient. For example, a phrase in the topic phrases 321 may be “VPN”, and the conversation router 190 may determine from this phrase that the conversation thread 221 should be sent to technical support personnel who specializes in VPN issues, and may select an appropriate recipient, for example, from a directory of technical support personnel. The conversation router 190 may send the conversation thread 221 to the selected recipient in any suitable manner using any suitable form of electronic communication. For example, the conversation router 190 may send a link to the conversation thread 221, may embed the conversation thread 221 in a message. The message sent by the conversation router with the conversation thread 221 may be sent to the selected recipient on a computing device 500, which may be any suitable computing device, such as the computing device in FIG. 8, that may be used by the selected recipient.

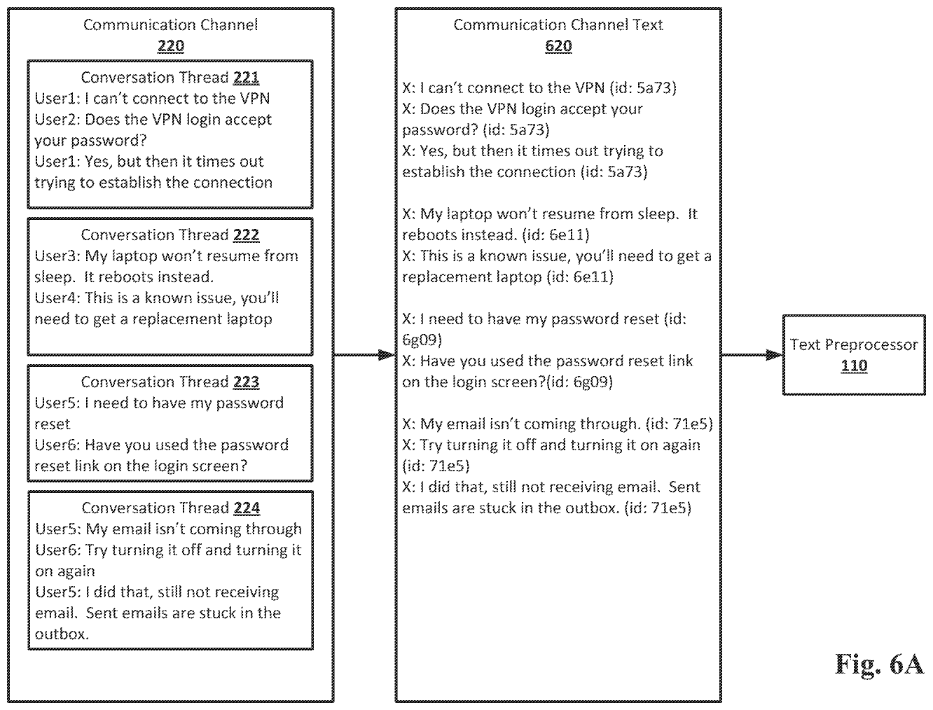

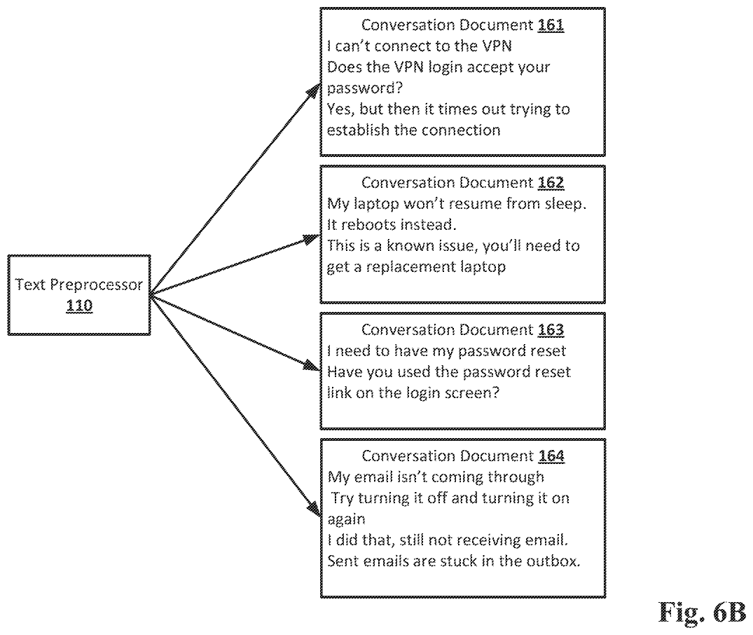

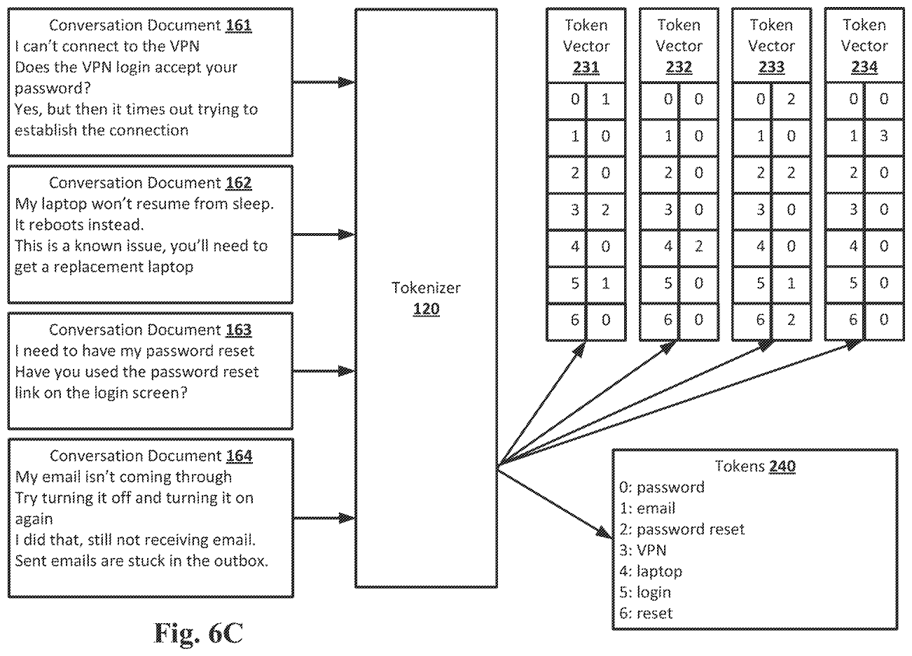

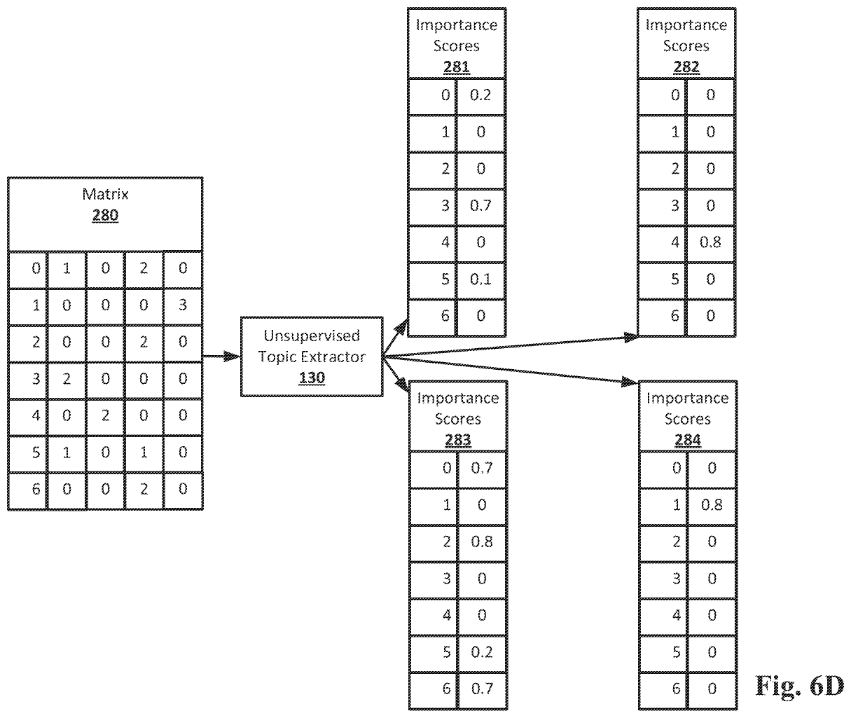

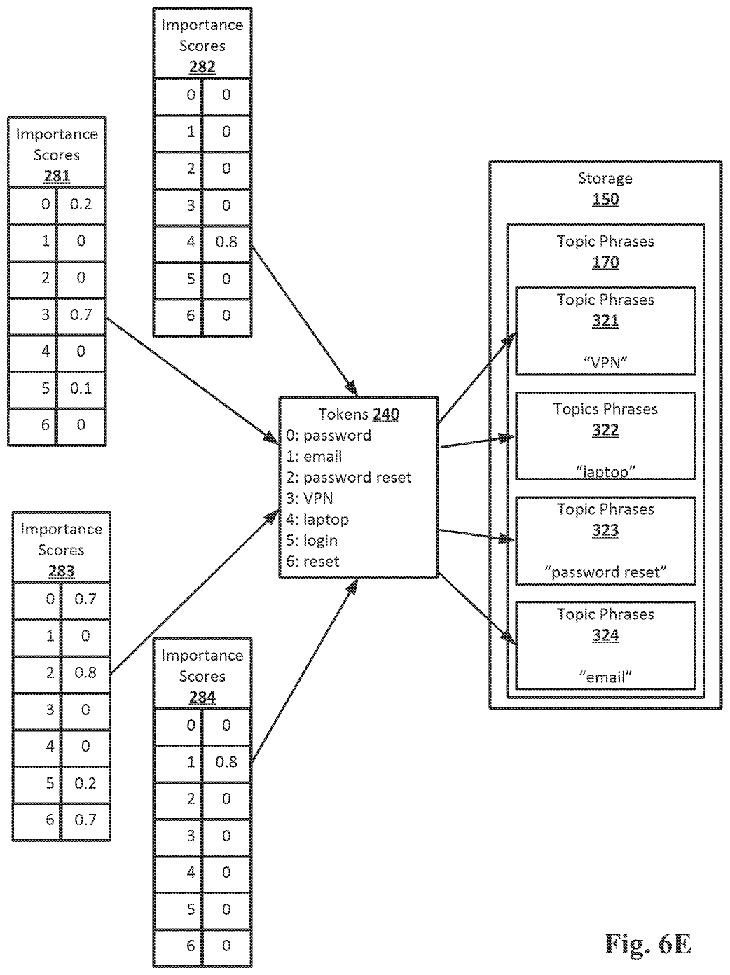

FIG. 6A shows an example arrangement suitable for conversation topic extraction according to an implementation of the disclosed subject matter. Communication channel text 620 may be prepared from the text in the messages of the conversations thread 221, 222, 223, and 224 of the communication channel 220. User identifiers may be removed, and conversation identifiers may be stored as part of the communication channel text 620 to allow messages from the different conversation threads 221, 222, 223, and 224 to be identified, maintain the threading of the communication channel 220. The communication channel text 620 may be prepared in any suitable manner by any suitable component of any computing device, such as the computing device 100. For example, the text preprocessor 110 may prepare the communication channel text 620 by accessing the communication channel 220 through an API of the communications platform 210. The text preprocessor 110 may receive the communication channel text 620.

FIG. 6B shows an example arrangement suitable for conversation topic extraction according to an implementation of the disclosed subject matter. The text preprocessor 620 may divide the communication channel text 620 into the conversation documents 161, 162, 163, and 164. Any remaining extraneous matter may be removed from the text of the communication channel text 620, and the conversations identifier may be used to divide the remaining text among the conversation documents 161, 162, 163, and 164 such that each has the text of messages from one of the conversations threads 221, 222, 223, and 224.

FIG. 6C shows an example arrangement suitable for conversation topic extraction according to an implementation of the disclosed subject matter. The tokenizer 120 may tokenize the conversation documents 161, 162, 163, and 164, generating the token vectors 231, 232, 233, and 234. The tokenizer 120 may, for example, count the occurrence of one-word, two-word, and three-word phrases in the conversation documents 161, 162, 163, and 164, and may determine that the six most frequently occurring phrases are “password”, “email”, “password reset”, “VPN”, “laptop”, “login”, and “reset.” These phrases may be tokens 240 for the conversation documents 161, 162, 163, and 164. The token vectors 231, 232, 233, 234 may have their indexes mapped to the tokens 240, for example, with, in each of the token vectors 231, 232, 233, and 234, the cell at index 0 storing the count for “password”, the cell at index 1 storing the count for “email”, the cell at index 2 storing the count for “password reset”, the cell at index 3 storing the count for “VPN”, the cell at index 4 storing the count for “laptop”, the cell at index 5 storing the count for “login”, and the cell at index 6 storing the count for “reset.” To generate the token vectors 231, 232, 233, and 234, the tokenizer 120 may count the occurrence of the phrases of the tokens 240 in each of the conversation documents 161, 162, 163, and 164, and store the count phrase in the cell whose index maps to the phrase as per the tokens 240. For example, the tokenizer 120 may count two occurrences of the phrase “VPN” in the conversation document 161 and may store a 2 in the cell at index 3 of the token vector 231. Similarly, the tokenizer 120 may count the one occurrence of the phrase “password” in the conversation document 161 and may store a 1 in the cell at index 0 of the token vector 231. The tokenizer 120 may count two occurrences of the phrase “password” in the conversation document 163 and may store a 2 in the cell at index 0 of the token vector 233. The tokenizer 120 may count the occurrence of each of the phrases in the tokens 240 in each of the conversation documents 161, 162, 163, and 164, and store the result of the count in the appropriate cells of the token vectors 231, 232, 233, and 234. This may result in the token vector 231 storing the count of the phrases from the tokens 240 in the conversation document 161, the token vector 232 storing the count of the phrases from the tokens 240 in the conversation document 162, the token vector 233 storing the count of the phrases from the tokens 240 in the conversation document 163, and the token vector 234 storing the count of the phrases from the tokens 240 in the conversation document 164.

FIG. 6D shows an example arrangement suitable for conversation topic extraction according to an implementation of the disclosed subject matter. The unsupervised topic extractor 130 may generate the importance scores 281, 282, 283, and 284 from the matrix 280, which may include the token vectors 231, 232, 233, and 234. The importance scores assigned to tokenized phrases for a token vector may indicate the likelihood that a tokenize phrase from the tokens 240 is a topic phrase for that token vector and its associated conversation document and conversation thread. For example, the tokenized phrase “VPN” may have the highest importance score in the importance scores 281, which may indicate that “VPN” should be used as a topic phrase for the token vector 231 and its associated conversation document 161 and conversation thread 221. The tokenized phrase “password reset” may have the highest importance score in the importance scores 283, which may indicate that “password reset” should be used as the topic phrase for the token vector 233 and its associated conversation document 162 and conversation thread 223.

FIG. 6E shows an example arrangement suitable for conversation topic extraction according to an implementation of the disclosed subject matter. The importance scores 281, 282, 283, and 284 may be used to determine the topic phrases 321, 322, 323, and 324. For each of the importance scores 281, 282, 283, and 284, the index of the cell with the highest importance score may be looked up in the tokens 240 to determine which tokenized phrase the importance score was assigned to. The tokenized phrase looked up into the tokens 240 based on the importance scores for a token vector may be used as the topic phrase for the conversation document, and conversation thread, associated with the token vector. For example, the importance scores 281 may be importance scores for the token vector 231, which may be associated with the conversation document 161 and the conversation thread 221. The cell at index 3 of the importance scores 281 may store the highest value of all of the cells in the importance scores 281. Index 3 may map to the tokenized phrase “VPN” in the tokens 240. The phrase “VPN” may be stored as part of the the topic phrases 321, which may be the topic phrases for the conversation document 161 and the conversation thread 221.

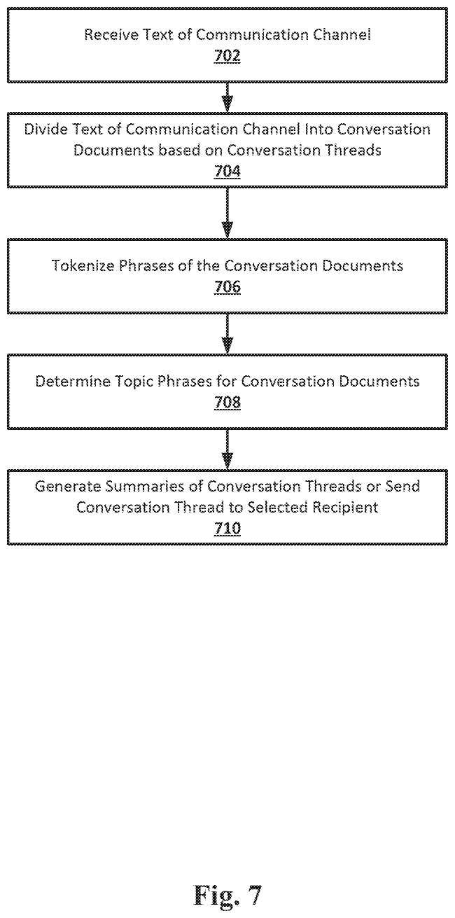

FIG. 7 shows an example procedure suitable for conversation topic extraction according to an implementation of the disclosed subject matter. At 702, text of a communication channel may be received. For example, the text preprocessor 110 on the computing device 100 may receive communication channel text 620 from the communications platform 210. The communication channel text 620 may include text of messages from conversation threads 221, 222, 223, and 224 of the communication channel 220, with user identifiers deidentified, removed, or obscured and conversation identifiers to preserve the threading of the messages. The text preprocessor 210 may receive the communication channel text 620 in any suitable manner and format, such as, for example, as a data file or through an API of the communications platform 210.

At 704, the text of the communication channel may be divided into conversation documents based on conversation threads. For example, the text preprocessor 110 may divide the communication channel text 620 into the conversation documents 161, 162, 163, and 164, which may include, respectively, text of the messages from the conversation threads 221, 222, 223, and 224. The text preprocessor 110 may use the conversation identifiers in the communication channel text 620 to determine how to divide the text in the communication channel text 620 into the conversation documents 161, 162, 163, and 164. The text preprocessor 110 may remove any non-text data, such as obscured user identifiers or conversation identifiers, when dividing the communication channel text 620 into the conversation documents 161, 162, 163, and 164, but may preserve punctuation and whitespace.

At 706, phrases of the conversation documents may be tokenized. For example, the tokenizer 120 may generate token vectors 231, 232, 233, and 234, and tokens 240, from the conversation documents 161, 162, 163, and 164 by counting the occurrence of phrases in the conversation documents 161, 162, 163, and 164. The tokenized phrases may be n-grams of words of any suitable length found in the conversation documents 161, 162, 163, and 164. The tokenizer 120 may also search the conversation documents 161, 162, 163, and 164 for known phrases related to a designated subject of the communication channel 220 when tokenizing phrases. The tokens 240 may include the phrases tokenized by the tokenizer 120, which may be any number of phrases that occur the most, for example, the top n most frequent phrases, across all of the conversation documents 161, 162, 163, and 164, and may map the tokenized phrases to index numbers that correspond to cells of the token vectors 231, 232, 233, and 234. The token vectors 231, 232, 233, and 234 may store counts of how many times the tokenized phrases in the tokens 240 occur in, respectively, the conversation documents 161, 162, 163, and 164.

At 708, topic phrases for the conversation documents may be determined. For example, the token vectors 231, 232, 233, and 234 may be input to the unsupervised topic extractor 130 as the matrix 280. The unsupervised topic extractor 130 may perform dimensionality reduction, such as NMF or LDA, on the matrix 280, generating matrices that may be used to assign importance scores 281, 282, 283, and 284 for the tokenized phrases in the tokens 240 on a per-token vector, and per conversation document, basis for the token vectors 231, 232, 233, and 234 and their associated conversation documents 161, 162, 163, and 164. The topic phrases with the highest n importance scores in the importance scores 281, 282, 283, and 284 for the respective conversation documents 231, 232, 233, and 234 may be stored, for example, as topic phrases 321, 322, 323, and 324, and may be used as topic phrases for the conversation threads 221, 222, 223, and 224.

In some implementations, the importance scores assigned by the unsupervised topic extractor 130 may be used with token vectors 231, 232, 233, and 234 and tokens 240 to generate the training data set 510 for the supervised topic extractor 140. The training data set 410 may, for example, include a subset of the importance scores 281, 282, 283, and 284, and may be used in the supervised training of the supervised topic extractor 140. The supervised topic extractor 140, after being trained with the training data set 410, may be used to update the assigned importance scores 281, 282, 283, and 284, for example, generating the importance scores 481, 482, 483, and 484 from the token vectors 231, 232, 233, and 234. The topic phrases with the highest n importance scores in the importance scores 481, 482, 483, and 484 for the respective conversation documents 231, 232, 233, and 234 may be stored, for example, as topic phrases 321, 322, 323, and 324, and may be used as topic phrases for the conversation threads 221, 222, 223, and 224.

At 710, summaries of conversation threads may be generated or a conversation thread may be sent to a selected recipient. For example, the summary generator 180 may generate a summary of the communication channel 220 using the topic phrases 321, 322, 323, and 324 for the conversation threads 221, 222, 223, and 224, along with, for example, samples of messages from the conversation threads 221, 222, 223, and 224. The conversation router 190 may select an appropriate recipient for a conversation thread, for example, the conversation thread 221, based on the topic phrases for that conversations thread, for example, the topic phrases 321. The conversation router 190 may send the conversation thread to the selected recipient in any suitable manner using any suitable form of electronic communication, for example, sending the recipient a message that includes a link to the conversation thread 221 or has the conversation thread 221 embedded in the message.

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving text of a communication channel;
dividing the text of the communication channel into conversation documents based on conversation threads of the communication channel;
tokenizing phrases of the text of the conversation documents; and
determining topic phrases for the conversation documents by assigning importance scores to the tokenized phrases using unsupervised topic extraction, wherein the topic phrases are the tokenized phrases with the highest importance scores.

2. The computer-implemented method of claim 1, further comprising:
generating a training data set with the importance scores assigned to the tokenized phrases; and
training a supervised topic extraction model using the training data set.

3. The computer-implemented method of claim 2, wherein assigning importance scores to the tokenized phrases further comprises using supervised topic extraction with the supervised topic extraction model on the tokenized phrases to update the importance scores assigned using unsupervised topic extraction.

4. The computer-implemented method of claim 1, further comprising:
sending a conversation thread of the communication channel to a recipient, wherein the recipient is selected based on the topic phrases for conversation document associated with the conversation thread.

5. The computer-implemented method of claim 1, further comprising generating a summary for the communication channel comprising the topic phrases for two or more of the conversation documents.

6. The computer-implemented method of claim 1, wherein tokenizing phrases of the text of the conversation documents further comprises searching the conversation documents for known phrases related to a designated subject of the communication channel.

7. The computer-implemented method of claim 1, wherein tokenizing phrases of the text of the conversation documents further comprises generating token vectors from the conversation documents.

8. The computer-implemented method of claim 7, wherein determining topic phrases for the conversation documents by assigning importance scores to the tokenized phrases using unsupervised topic extraction further comprises:
generating a matrix using the token vectors; and
performing dimensionality reduction on the matrix.

9. A computer-implemented system comprising:
a processor that receives text of a communication channel,
divides the text of the communication channel into conversation documents based on conversation threads of the communication channel;
tokenizes phrases of the text of the conversation documents; and
determines topic phrases for the conversation documents by assigning importance scores to the tokenized phrases using unsupervised topic extraction, wherein the topic phrases are the tokenized phrases with the highest importance scores.

10. The computer-implemented system of claim 9, wherein the processor further generates a training data set with the importance scores assigned to the tokenized phrases and trains a supervised topic extraction model using the training data set.

11. The computer-implemented system of claim 10, wherein the processor assigns importance scores to the tokenized phrases further by using supervised topic extraction with the supervised topic extraction model on the tokenized phrases to update the importance scores assigned using unsupervised topic extraction.

12. The computer-implemented system of claim 9, wherein the processor further sends a conversation thread of the communication channel to a recipient, wherein the recipient is selected based on the topic phrases for conversation document associated with the conversation thread.

13. The computer-implemented system of claim 9, wherein the processor further generates a summary for the communication channel comprising the topic phrases for two or more of the conversation documents.

14. The computer-implemented system of claim 9, wherein the processor tokenizes phrases of the text of the conversation documents further by searching the conversation documents for known phrases related to a designated subject of the communication channel.

15. The computer-implemented system of claim 9, wherein the processor tokenizes phrases of the text of the conversation documents further by generating token vectors from the conversation documents.

16. The computer-implemented system of claim 15, wherein the processor determines topic phrases for the conversation documents by assigning importance scores to the tokenized phrases using unsupervised topic extraction by:
generating a matrix using the token vectors, and
performing dimensionality reduction on the matrix.

17. A system comprising: one or more computers and one or more non-transitory storage devices storing instructions which are operable, when executed by the one or more computers, to cause the one or more computers to perform operations comprising:
receiving text of a communication channel;
dividing the text of the communication channel into conversation documents based on conversation threads of the communication channel;
tokenizing phrases of the text of the conversation documents; and
determining topic phrases for the conversation documents by assigning importance scores to the tokenized phrases using unsupervised topic extraction, wherein the topic phrases are the tokenized phrases with the highest importance scores.

18. The system of claim 17, wherein the one or more computers and one or more non-transitory storage devices further store instructions which are operable, when executed by the one or more computers, to cause the one or more computers to further perform operations comprising:
generating a training data set with the importance scores assigned to the tokenized phrases; and
training a supervised topic extraction model using the training data set.

19. The system of claim 18, wherein the one or more computers and one or more non-transitory storage devices further store instructions which are operable, when executed by the one or more computers, to cause the one or more computers to perform the operation of assigning importance scores to the tokenized phrases by using supervised topic extraction with the supervised topic extraction model on the tokenized phrases to update the importance scores assigned using unsupervised topic extraction.

20. The system of claim 17, wherein the one or more computers and one or more non-transitory storage devices further store instructions which are operable, when executed by the one or more computers, to cause the one or more computers to further perform operations comprising:
sending a conversation thread of the communication channel to a recipient, wherein the recipient is selected based on the topic phrases for conversation document associated with the conversation thread.
